(19) United States
(12) Patent Application Publication
(10) Pub. No.: US 2025/0286183 A1
(43) Pub. Date: Sep. 11, 2025

(54) BIPOLAR BATTERY

(71) Applicant: TOYOTA JIDOSHA KABUSHIKI KAISHA, Aichi-ken (JP)

(72) Inventor: Nobuo MATSUI, Toyota-shi (JP)

(21) Appl. No.: 19/057,986

(22) Filed: Feb. 20, 2025

(30) Foreign Application Priority Data
Mar. 5, 2024 (JP) 2024-033246

(51) Int. Cl. H01M 50/198; H01M 10/04; H01M 50/186; H01M 50/489

(52) U.S. Cl. CPC H01M 50/198; H01M 10/0418; H01M 10/0486; H01M 50/186; H01M 50/489

(57) ABSTRACT

Provided are: plural bipolar electrodes; a separator positioned between a negative electrode active material layer and a positive electrode active material layer which are adjacent to each other; plural primary sealing materials provided at an outer peripheral portion of the current collector, the outer peripheral portion being a region at which the negative electrode active material layer and the positive electrode active material layer are not provided; a secondary sealing material provided at an outer peripheral portion of all of the primary sealing materials; and an electrolytic solution provided at an internal space V, wherein, in a case in which a melting temperature of the primary sealing materials is defined as mp1, a normal battery operating temperature is defined as nth, a boiling point of the electrolytic solution is defined as bp, and a melting temperature of the separator is defined as smp, nth<mp1<bp and nth<mp1<smp.

### CROSS-REFERENCE TO RELATED APPLICATION

This application is based on and claims priority under 35 USC 119 from Japanese Patent Application No. 2024-033246 on Mar. 5, 2024 the disclosure of which is incorporated by reference herein.

### BACKGROUND

### Technical Field

The present disclosure relates to a bipolar battery.

### Related Art

Japanese Patent Application Laid-Open (JP-A) No. 2019-091606 discloses a bipolar battery. The bipolar battery includes a negative terminal electrode, a positive terminal electrode, plural bipolar electrodes, plural separators, plural primary sealing materials, a secondary sealing material, and an electrolytic solution. Each bipolar electrode is provided between the negative terminal electrode and the positive terminal electrode. Each separator is positioned between an adjacent negative electrode active material layer and positive electrode active material layer which are provided at each electrode. Each primary sealing material is a frame-like member which is provided at an outer peripheral portion of a current collector of each electrode. The secondary sealing material is a frame-like member which is provided at an outer circumferential portion of all of the primary sealing materials.

### SUMMARY

There is room for improvement regarding forced discharge when the temperature is raised, in the bipolar battery of Japanese Patent Application Laid-Open (JP-A) No. 2019-091606.

In consideration of the above-described circumstances, an object of the present disclosure is to obtain a bipolar battery for which forced discharge performed at the time of temperature rise is difficult to be prevented.

### Means for Solving the Problem

A bipolar battery according to a first aspect includes: plural bipolar electrodes each including a current collector, a negative electrode active material layer provided on one face of the current collector, and a positive electrode active material layer provided on another face of the current collector; a separator positioned between the negative electrode active material layer and the positive electrode active material layer which are adjacent to each other; plural frame-like primary sealing materials provided at an outer peripheral portion of the current collector, the outer peripheral portion being a region at which the negative electrode active material layer and the positive electrode active material layer are not provided; a single frame-like secondary sealing material provided at an outer peripheral portion of all of the primary sealing materials; and an electrolytic solution provided at an internal space surrounded by the current collector, the primary sealing materials, and the secondary sealing material, wherein, in a case in which a melting temperature of the primary sealing materials is defined as mp1, a normal battery operating temperature is defined as nth, a boiling point of the electrolytic solution is defined as bp, and a melting temperature of the separator is defined as smp, nth<mp1<bp and nth<mp1<smp.

In the bipolar battery according to the first aspect, an electrolytic solution is provided at an internal space surrounded by the current collector, the primary sealing materials, and the secondary sealing material. Therefore, in a case in which the temperature of the bipolar battery is at the normal battery operating temperature nth, the electrolytic solution provided at one internal space does not flow through a primary seal into an adjacent internal space.

Further, in the bipolar battery according to the first aspect, in a case in which the melting temperature of the primary sealing materials is defined as mp1, the normal battery operating temperature is defined as nth, the boiling point of the electrolytic solution is defined as bp, and the melting temperature of the separator is defined as smp, nth<mp1<bp and nth<mp1<smp. Therefore, in a case in which the temperature of the bipolar battery is higher than the normal battery operating temperature nth, the primary sealing materials are melted before the temperature of the electrolytic solution reaches the boiling point bp. As a result, in a case in which the temperature of the bipolar battery is higher than the normal battery operating temperature nth, the electrolytic solution provided at one internal space can pass through the region in which the primary sealing materials were present and flow into the adjacent internal space. Therefore, forced discharge occurs between the negative electrode active material layer and the positive electrode active material layer provided at both sides of the current collector by the electrolytic solution having flowed into the adjacent internal space. Namely, the negative electrode active material layer and the positive electrode active material layer provided at both sides of the current collector are equalized in potential.

Furthermore, in the bipolar battery according to the first aspect, when the temperature of the bipolar battery further rises after forced discharge has occurred between the negative electrode active material layer and the positive electrode active material layer provided at both sides of the current collector, the separator may be melted. However, the negative electrode active material layer and the positive electrode active material layer positioned at both sides of the separator are at equal potentials prior to melting of the separator, such that there is little risk of an excessive increase in the temperature of the bipolar battery.

A bipolar battery according to a second aspect is the bipolar battery according to the first aspect, wherein bp is higher than mp1 by 50° C. or more.

In the bipolar battery according to the second aspect, the boiling point bp of the electrolytic solution is higher than the melting temperature mp1 of the primary sealing materials by 50° C. or more, such that a state in which the temperature of the bipolar battery is higher than or equal to the melting temperature mp1 of the primary sealing materials and lower than the boiling point bp of the electrolytic solution is easily maintained for a certain period of time.

As explained above, the bipolar battery according to the present disclosure has an excellent advantageous effect in that forced discharge performed at the time of temperature increase is difficult to be prevented.

### BRIEF DESCRIPTION OF THE DRAWINGS

Exemplary embodiments of the present disclosure will be described in detail based on the following figures, wherein:

FIG. 1 is a perspective view of a bipolar battery according to an exemplary embodiment.

FIG. 2 is a schematic cross-section view taken along line 2-2 in FIG. 1.

FIG. 3 is a cross-section view corresponding to FIG. 2, when a primary seal has been melted.

FIG. 4 is a cross-section view corresponding to FIG. 2, when a separator has been melted.

### DETAILED DESCRIPTION

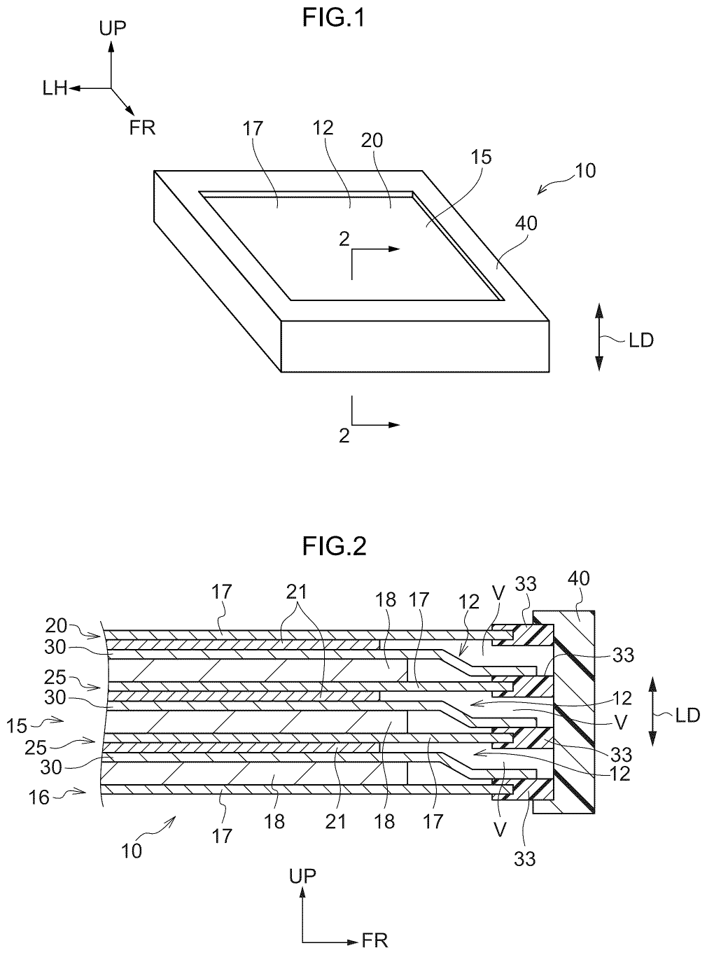

FIG. 1 illustrates a bipolar battery 10 (hereafter, referred to as a battery 10) according to an exemplary embodiment. The battery 10, serving as a secondary battery, can be installed at various devices. For example, the battery 10 is installed at an electric vehicle (battery electric vehicle (BEV)), and can supply electric power to an electric motor that serves as a drive source. It should be noted that in each of the drawings, the arrow UP, the arrow FR, and the arrow LH respectively indicate an upper side in an up-down direction, a front side in a front-rear direction, and a left side in a left-right direction.

First, explanation follows regarding a configuration of the battery 10. The battery 10 according to the present exemplary embodiment includes a laminated body 15, primary sealing materials 33, and a single secondary sealing material 40.

The laminated body 15 includes plural battery cells 12. The configuration of the laminated body 15 is well known, and therefore, the following explanation of the laminated body 15 is simplified. The laminated body 15 includes a single negative terminal electrode (electrode) 16, a single positive terminal electrode (electrode) 20, plural bipolar electrodes (electrodes) 25, and plural separators 30. Each bipolar electrode 25 is positioned between the negative terminal electrode 16 and the positive terminal electrode 20. Each separator 30 is positioned between the positive terminal electrode 20, the negative terminal electrode 16, and the bipolar electrode 25 which are adjacent to each other. It should be noted that although the battery 10 that is illustrated in FIG. 2 to FIG. 4 includes two bipolar electrodes 25, as long as there are plural bipolar electrodes 25, any number may be used.

The negative terminal electrode 16 that configures a lower end portion of the laminated body 15 includes a current collector (current collector foil) 17, a negative electrode active material layer 18 provided at one face of the current collector 17, a conductive auxiliary agent, and a binder. The current collector 17 of the negative terminal electrode 16 is, for example, a nickel foil, the negative electrode active material layer 18 is natural graphite, and the binder is SBR/CMC. The positive terminal electrode 20 that configures an upper end portion of the laminated body 15 includes a current collector 17, a positive electrode active material layer 21 provided at one face of the current collector 17, a conductive auxiliary agent, and a binder. The current collector 17 of the positive terminal electrode 20 is, for example, an aluminum foil, the positive electrode active material layer 21 is an NCM-based active material, the conductive auxiliary agent is carbon black, and the binder is PVdF. Each bipolar electrode 25 that is positioned between the negative terminal electrode 16 and the positive terminal electrode 20 includes a current collector 17, a negative electrode active material layer 18 provided at both sides of the current collector 17, a conductive auxiliary agent at a negative electrode active material layer 18 side, a binder at the negative electrode active material layer 18 side, a positive electrode active material layer 21, a conductive auxiliary agent at a positive electrode active material layer 21 side, and a binder at the positive electrode active material layer 21 side. The negative electrode active material layer 18 of the bipolar electrode 25, the conductive auxiliary agent at the negative electrode active material layer 18 side, and the binding agent at the negative electrode active material layer 18 side are each the same as the negative electrode active material layer 18, the conductive auxiliary agent, and the binding agent of the negative terminal electrode 16, and the positive electrode active material layer 21 of the bipolar electrode 25, the conductive auxiliary agent at the positive electrode active material layer 21 side, and the binding agent at the positive electrode active material layer 21 side are each the same as the positive electrode active material layer 21, the conductive auxiliary agent, and the binding agent of the positive terminal electrode 20. The laminated body 15 is configured by laminating the negative terminal electrode 16, the positive terminal electrode 20, the plural bipolar electrodes 25, and the plural separators 30 in a laminating direction LD. In FIG. 1 and FIG. 2, the laminating direction LD is parallel to the up-down direction.

The planar shape of the separator 30 is a rectangle, and an outer peripheral portion of the separator 30 is positioned at a level lower compared to a portion other than the outer peripheral portion. The outer peripheral portion of the separator 30 is welded (spot welded) to the adjacent primary sealing material 33. The separator 30 is a laminated body in which a sheet made of polyethylene (PE) is sandwiched between a pair of polypropylene (PP) sheets from above and below. The thickness of the separator 30 is, for example, 20 μm. The planar shapes of the negative terminal electrode 16, the positive terminal electrode 20, the bipolar electrodes 25, and the separators 30 of the present exemplary embodiment are rectangles. Therefore, the planar shape of the laminated body 15 is a rectangle. The respective separators 30, and the negative electrode active material layer 18 and the positive electrode active material layer 21 positioned above and below the separators 30 are constituent elements of the battery cell 12.

As illustrated in FIG. 2, a primary sealing material 33 made of a resin is provided at an outer peripheral portion of each current collector 17, the outer peripheral portion of the current collector 17 being a region at which the negative electrode active material layer 18 and the positive electrode active material layer 21 are not formed. The primary sealing material 33 is a frame-like body with a planar shape that is a rectangle, and a groove is provided on an entire inner peripheral face of the primary sealing material 33. The primary sealing material 33 is welded to the current collector 17 in a state in which the outer peripheral portion of the current collector 17 is inserted into the groove of the primary sealing material 33.

When the laminated body 15 is configured as illustrated in FIG. 2, an outer peripheral portion of the laminated body 15 is surrounded by plural primary sealing materials 33. A single secondary sealing material 40, serving as a frame-like body having a rectangular shape in plan view, is molded at the outer peripheral portion of each primary sealing material 33 by injection molding that is performed in a state in which the laminated body 15 and the plural primary sealing materials 33 are positioned inside a molding die, which is not illustrated in the drawings. The type of resin material that serves as a constituent material of the secondary sealing material 40 is different from the type of resin material that serves as a constituent material of the primary sealing materials 33. Plural communication holes (not illustrated in the drawings), which respectively communicate with a front end portion of an internal space V of each battery cell 12 in an airtight state and a liquid-tight state, are provided at a front portion of the secondary sealing material 40.

Further, a liquid injection frame, which is not illustrated in the drawings, is integrally provided with the secondary sealing material 40 at a front end face of the secondary sealing material 40 during the above-described injection molding. The liquid injection frame is a hollow body, and a front end portion of the liquid injection frame is open. Plural communication holes (not illustrated in the drawings) that communicate with, in an airtight state and a liquid-tight state, the above-described respective communication holes are provided at a bottom plate portion (rear plate portion) of the liquid injection frame.

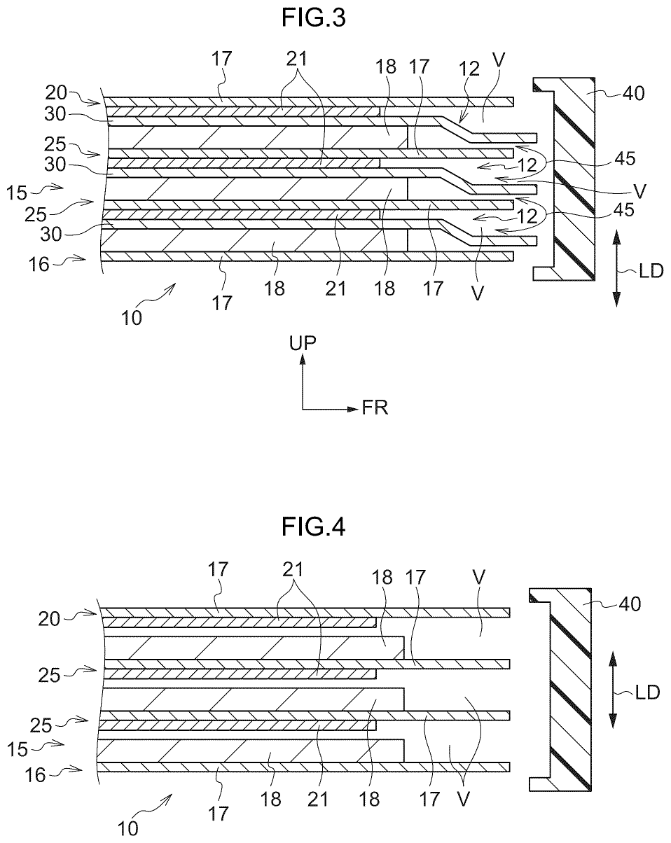

An electrolytic solution 45 (see FIG. 3) is filled into each internal space V via a front end opening portion of the liquid injection frame, an internal space, and the above-described communication holes, and the communication holes of the secondary sealing material 40. After the electrolytic solution 45 has been filled, a front end face of the liquid injection frame is closed by a film-like member (not illustrated in the drawings) which is made of a resin.

The primary sealing materials 33, the secondary sealing material 40, and the liquid injection frame of the battery 10 having such a configuration are each configured by a resin material having insulation properties. The resin material of the primary sealing materials 33 is low density PE (polyethylene), and the melting temperature mp1 of the primary sealing materials 33 is from 100 to 115° C. The resin material of the secondary sealing material 40 is a different type of resin material than the low density PE. Further, the electrolytic solution 45 is, for example, a mixed solution of ethylene carbonate (EC), ethyl methyl carbonate (EMC), and/or dimethyl carbonate (DMC). The boiling point bp of the electrolytic solution 45 is a temperature between 10° and 230° C. However, the boiling point bp of the electrolytic solution 45 needs to be higher than the melting temperature mp1. Therefore, in a case in which the melting temperature mp1 is 115° C., for example, it is necessary to adjust the mixing ratio of ethylene carbonate (EC), the ethyl methyl carbonate (EMC), and/or the dimethyl carbonate (DMC) such that the boiling point bp of the electrolytic solution 45 is higher than 115° C. In the present exemplary embodiment, the mixing ratio of EC, EMC, and/or DMC is 1:1:1. It is further preferable that the boiling point bp of the electrolytic solution 45 is higher than the melting temperature mp1 by 50° C. or more.

A melting temperature smp of the separators 30 is higher than 160° C. The temperature of the battery 10 when the battery 10 is in a normal use state is defined as a normal battery operating temperature nth. The normal battery operating temperature nth is, for example, a temperature of less than 70° C. In the present exemplary embodiment, the following Expression (1) is satisfied.

nth<mp1<bp and nth<mp1<smp Expression (1):

The battery 10 stores (charges) when a voltage is applied from a DC power source.

### Operation and Effects

Next, explanation follows regarding the operation and advantageous effects of the present exemplary embodiment.

Here, assume a case in which an electric vehicle that is installed with the battery 10 travels using force generated by an electric motor that is supplied with power from the battery 10, and the battery 10 is not being charged or excessive charging has not been performed. The temperature of the battery 10 at this time is included in the normal battery operating temperature nth.

Next, assume a case in which, for example, voltage continues to be applied to the battery 10 despite the battery 10 being sufficiently charged, such that the battery 10 has increased in temperature to a temperature higher than the normal battery operating temperature nth.

In the present exemplary embodiment, Expression (1) is satisfied. Therefore, a state occurs in which the temperature of the battery 10 is higher than or equal to the melting temperature mp1 and lower than the boiling point bp when the temperature of the battery 10 has become high. In particular, in a case in which the boiling point bp is higher than the melting temperature mp1 by 50° C. or more, a state in which the temperature of the battery 10 is higher than or equal to the melting temperature mp1 and lower than the boiling point bp is easily maintained for a certain period of time. In such a case, as illustrated in FIG. 3, each primary sealing material 33 is melted. Therefore, the electrolytic solution 45 is capable of moving between the internal spaces V positioned above and below each current collector 17, passing through the region in which the primary sealing material 33 was present. As a result, the negative electrode active material layer 18 that is provided at an upper face of each current collector 17 and the positive electrode active material layer 21 that is provided at a lower face of each current collector 17 are in liquid communication with each other by the electrolytic solution 45. Namely, the negative electrode active material layer 18 that is provided at the upper face of each current collector 17 and the positive electrode active material layer 21 that is provided at the lower face of each current collector 17 are forcibly discharged, and the negative electrode active material layer 18 and the positive electrode active material layer 21 are equalized in potential. Therefore, even if each separator 30 is shut down due to the temperature of each separator 30 becoming high, the negative electrode active material layer 18 that is provided at the upper face of each current collector 17 and the positive electrode active material layer 21 that is provided at the lower face of each current collector 17 are forcibly discharged using the electrolytic solution 45.

Thereafter, when the temperature of the battery 10 further increases, and the temperature of the battery 10 becomes higher than or equal to the melting temperature smp, the respective separators 30 are melted, as illustrated in FIG. 4. Therefore, the negative electrode active material layer 18 and the positive electrode active material layer 21 of the adjacent electrodes 16, 20, and 25 face each other in the up-down direction. As a result, the negative electrode active material layer 18 and the positive electrode active material layer 21 facing each other in the up-down direction may be surface short-circuited. However, even if a surface short circuit has occurred, the negative electrode active material layer 18 and the positive electrode active material layer 21 are already equalized in potential, such that there is little risk of the battery 10 becoming excessively high in temperature.

Although the battery 10 according to an exemplary embodiment has been explained as above, the battery 10 can be appropriately modified in design within a range that does not depart from the gist of the present disclosure.

For example, the materials of the current collectors 17, the negative electrode active material layer 18, the positive electrode active material layer 21, the separators 30, the primary sealing materials 33, the secondary sealing material 40, and the electrolytic solution 45 may be different from those described above.

What is claimed is:

1. A bipolar battery, comprising:
a plurality of bipolar electrodes each including a current collector, a negative electrode active material layer provided on one face of the current collector, and a positive electrode active material layer provided on another face of the current collector;
a separator positioned between the negative electrode active material layer and the positive electrode active material layer, which are adjacent to each other;
a plurality of frame-like primary sealing materials provided at an outer peripheral portion of the current collector, the outer peripheral portion being a region at which the negative electrode active material layer and the positive electrode active material layer are not provided;
a single frame-like secondary sealing material provided at an outer peripheral portion of all of the primary sealing materials; and
an electrolytic solution provided at an internal space surrounded by the current collector, the primary sealing materials, and the secondary sealing material,
wherein, in a case in which a melting temperature of the primary sealing materials is defined as mp1, a normal battery operating temperature is defined as nth, a boiling point of the electrolytic solution is defined as bp, and a melting temperature of the separator is defined as smp, nth<mp1<bp and nth<mp1<smp.

2. The bipolar battery according to claim 1, wherein bp is higher than mp1 by 50° C. or more.
